(19) United States
(12) Patent Application Publication
(10) Pub. No.: US 2012/0052322 A1
(43) Pub. Date: Mar. 1, 2012

(54) METHOD OF BONDING DISSIMILAR METAL MATERIALS AND BONDED BODY OF DISSIMILAR METAL MATERIALS

(75) Inventors: Tomonobu HATAKEYAMA, Shizuoka-Ken (JP); Gouki YOTSUYA, Shizuoka-Ken (JP)

(73) Assignee: SUZUKI MOTOR CORPORATION, Shizuoka-Ken (JP)

(21) Appl. No.: 13/193,405

(22) Filed: Jul. 28, 2011

(30) Foreign Application Priority Data
Aug. 31, 2010 (JP) 2010-194541

(51) Int. Cl. B32B 15/01; B23K 20/12

(52) U.S. Cl. 428/650; 428/615; 228/112.1

(57) ABSTRACT

A method of bonding dissimilar metal materials each having a different melting point, including: positioning a steel member and an aluminum member to a bonding position; press-contacting a rotation tool to the steel member while the rotation tool is rotated, and inserting the rotation tool into the steel member; controlling an insertion position of the rotation tool to a position where the rotation tool does not break through the steel member; producing a friction heat at a portion between the steel member and the rotation tool; partially softening the steel member and the aluminum member by a conduction heat conducted from the friction heat thereby to allow the two members to cause a plastic flow; and partially stirring the steel member and the aluminum member by the rotation tool thereby to friction-stir weld the steel member and the aluminum member.

### PRIORITY CLAIM

This patent application claims priority to Japanese Patent Application No. 2010-194541, filed 31 Aug. 2010, the disclosure of which is incorporated herein by reference in its entirety.

### BACKGROUND

1. Field

Disclosed embodiments relate to a method of bonding dissimilar (different) metal materials, in which the different metal materials are bonded by a friction stir welding, and a bonded body of dissimilar metal materials, the bonded body being obtainable through this bonding method.

2. Related Art

A bonding operation for bonding dissimilar metal materials such as steel member and aluminum member has been generally performed by a melt welding method or a mechanical bonding method using rivet or the like.

However, in case of the melt welding method, an amount of heat to be inputted to a welding portion is large, brittle intermetallic compounds (such as Fe2A15, FeAl3 or the like) are liable to be formed at a boundary surface between the steel member and the aluminum member, so that there may be posed a problem that a bonding strength of the bonded two members is disadvantageously lowered. Further, in case of the mechanical bonding method using rivet or bolt, an extra material such as rivet or the like is required for the bonding operation, thus resulting in a rise in manufacturing cost.

Therefore, in recent years, there has been advanced a research for bonding the steel member with the aluminum member through FSW (Friction Stir Welding) method in which the members to be bonded are not molten but softened so as to exhibit a plastic flow whereby the two members are solid-state bonded (solid-state welded). In this friction stir welding method, a FSW tool made of general tool steel is used, and this FSW tool is contacted with only the aluminum member whereby the steel member and the aluminum member are friction-stir welded (refer to Patent Literature 1, Patent Literature 2, or the like).

For example, in the friction stir welding method disclosed in the Patent Literature 1, a bonding surface of the steel member is covered with an oxidation prevention film (Zn plating), the steel member and the aluminum member are superposed. Under this superposed state, the FSW tool while being rotated is abut against the aluminum member, and then, the FSW tool is inserted into the aluminum member, so that the aluminum member and the Zn plating are softened due to friction heat thereby to exhibit the plastic flow, whereby the Zn plating is removed and a surface of the steel member exposes a new texture surface. As a result, the aluminum member exhibiting the plastic flow and the new texture surface of the steel member are solid-state bonded.

### PRIOR ART DOCUMENT

### Patent Document

[Patent Document 1] Japanese Patent Laid-Open Publication: No. 2005-34879
[Patent Document 2] Japanese Patent Laid-Open Publication: No. 2006-239720

However, in case of the friction stir welding method in which the FSW tool is not contacted with the steel member but contacted with only the aluminum member, since the steel member and the aluminum member are not sufficiently stirred, a high bonding strength of the two members cannot be obtained. Namely, in a case where the FSW tool is contacted with the aluminum member and inserted therein, when a temperature of the aluminum member is raised to a point immediately below the melting point of the aluminum member, this aluminum member is softened to exhibit and perform the plastic flow, so that a friction between the FSW tool and the aluminum member is lowered. As a result, an additional heat generation (further friction heat) cannot be obtained any more. Therefore, a temperature of the steel member cannot be arisen to a temperature enabling the steel member to perform the plastic flow, thus resulting in a state where only the aluminum member is stirred. Therefore, the steel member and the aluminum member are not sufficiently stirred, and the high bonding strength of the two members cannot be obtained.

As one countermeasure, in a case where a FSW tool made of general tool steel is used and the FSW tool is contacted with a steel member while the FSW tool is rotated in accordance with a conventional technique, there may be a fear such that the FSW tool becomes to be worn or broken due to the friction heat

As another countermeasure, it has been considered to use a FSW tool made of special material such as PCBN (poly crystalline cubic boron nitride) which hardly causes a wear and breakage even if the PCBN is contacted with the steel member. However, such FSW tool made of PCBN per se is very expensive, so that there may be posed a problem that a cost required for performing the friction-stir welding is disadvantageously increased.

### SUMMARY

The disclosed embodiments solve the afore-mentioned problems, and accordingly, the disclosed embodiments provide a method of bonding dissimilar (different) metal materials and a bonded body of the dissimilar metal materials, that are capable of greatly improving a bonding strength, particularly, a peel strength of the dissimilar metal materials.

Further, another disclosed embodiment provides a method of bonding dissimilar metal materials and a bonded body of the dissimilar metal materials, capable of effectively preventing the rotation tool used for the friction-stir welding from being broken or damaged.

In order to solve the afore-mentioned problems, disclosed embodiments provide a method of bonding dissimilar metal materials each having a different melting point, the method including the steps of: positioning a high melting point metal material and a low melting point metal material to a bonding position at which the dissimilar metal materials are bonded; press-contacting a rotation tool to the high melting point metal material while the rotation tool is rotated, and inserting the rotation tool into the high melting point metal material; controlling an insertion position of the rotation tool to a position where the rotation tool does not break through the high melting point metal material; producing a friction heat at a portion between the high melting point metal material and the rotation tool; partially softening the high melting point metal material and the low melting point metal material by a conduction heat conducted torn the friction heat thereby to allow the high and low melting point metal materials to cause a plastic flow; and partially stirring the high melting point metal material and the low melting point metal material by means of the rotation tool thereby to friction-stir weld the high melting point metal material and the low melting point metal material.

Further, a bonded body of dissimilar metal materials of the disclosed embodiments is obtained by bonding the high melting point metal material with the low melting point metal material in accordance with the aforementioned method of bonding dissimilar metal materials.

According to the method of bonding dissimilar metal materials and the bonded body of the dissimilar metal materials of the disclosed embodiments, when the rotation tool is inserted into the high melting point metal material from a side thereof, the high melting point metal material produces a friction heat and is heated to a temperature at which the high melting point metal material is softened and allowed to cause a plastic flow, and the low melting point metal material is also softened and allowed to cause a plastic flow due to a conduction heat conducted from the friction heat.

Therefore, the high melting point metal material and the low melting point metal material can be partially and sufficiently stirred by means of the rotation tool, so that the both metal materials can be bonded (welded) with a high bonding strength.

Further, an insertion position (insertion depth) of the rotation tool is controlled to a position where the rotation tool does not break through (penetrate through) the high melting point metal material, so that a bonded surface of the high melting point metal material and the low melting point metal material can be sufficiently secured. As a result, the bonding strength, particularly, a peel strength of the both dissimilar metal materials can be greatly improved.

### BRIEF DESCRIPTION OF THE DRAWINGS

FIG. 1 is a side view schematically showing an operating situation of a friction stir welding method to which one embodiment of the method of bonding dissimilar metal materials is applied.

FIG. 2 is a photograph showing an outer appearance of a bonded portion of a friction-stir-welding bonded body (a bonded body of a soft steel plate and an aluminum expanded plate) which is obtained by the friction-stir welding method shown in FIG. 1.

FIG. 3 is a view showing a cross section of periphery of the bonded portion shown in FIG. 2, FIG. 3A is a photograph showing the cross section of periphery of the bonded portion, FIG. 3B is a view schematically showing the cross section shown in FIG. 3A, FIG. 3C is an enlarged photograph showing a cross section of IIIC portion indicated in FIG. 3A, and FIG. 3D is an enlarged photograph showing a cross section of IIID portion indicated in FIG. 3A.

FIG. 4 is a view showing a cross section of periphery of the bonded portion of a friction stir welding bonded body (a bonded body of a soft steel plate and an aluminum cast plate) obtained by the friction stir welding method shown in FIG. 1, FIG. 4A is a photograph showing the cross-section of periphery of the bonded portion, FIG. 4B is an enlarged photograph showing a cross section of IVB portion indicated in FIG. 4A, FIG. 4C is an enlarged photograph showing a cross section of IVC portion indicated in FIG. 4A, and FIG. 4D is an enlarged photograph showing a cross section of IVD portion indicated in FIG. 4A.

FIG. 5 is a view showing a cross section of periphery of the bonded portion of a friction stir welding bonded body (a bonded body of a soft steel plate and an aluminum die cast plate) obtained by the friction stir welding method shown in FIG. 1, FIG. 5A is a photograph showing the cross-section of periphery of the bonded portion, FIG. 5B is an enlarged photograph showing a cross section of VB portion indicated in FIG. 5A, FIG. 5C is an enlarged photograph showing a cross section of VC portion indicated in FIG. 5A, and FIG. 5D is an enlarged photograph showing a cross section of VD portion indicated in FIG. 5A.

FIG. 6 is a graph showing a relation between a peel strength of the friction stir welding bonded body and an insertion depth (insertion position) of the rotation tool.

FIG. 7 is a graph showing a relation between a peel strength of the friction stir welding bonded body and a diameter of the rotation tool.

FIG. 8 is a side view schematically showing an operating situation of a conventional friction stir welding method.

FIG. 9 is a view showing a cross section of periphery of the bonded portion of a friction stir welding bonded body obtained by the friction stir welding method shown in FIG. 8, FIG. 9A is a photograph showing the cross section of periphery of the bonded portion, FIG. 9B is a view schematically showing the cross section shown in FIG. 9A.

FIG. 10 is a graph comparatively showing a peel strength and a cross tensile strength of the friction stir welding bonded body 15 shown in FIGS. 2 to 3 and the friction stir welding bonded body shown in FIG. 9.

FIG. 11 is a view explaining a method of testing strengths of a bonded body, FIG. 11A is a view explaining a method of testing a peel strength and FIG. 11B is a view explaining a method of testing a cross tensile strength

### DESCRIPTION OF THE DISCLOSED EMBODIMENTS

Next, a best mode the disclosed embodiments will be described with reference to the accompanying drawings. It is noted that the present invention is not limited to these embodiments.

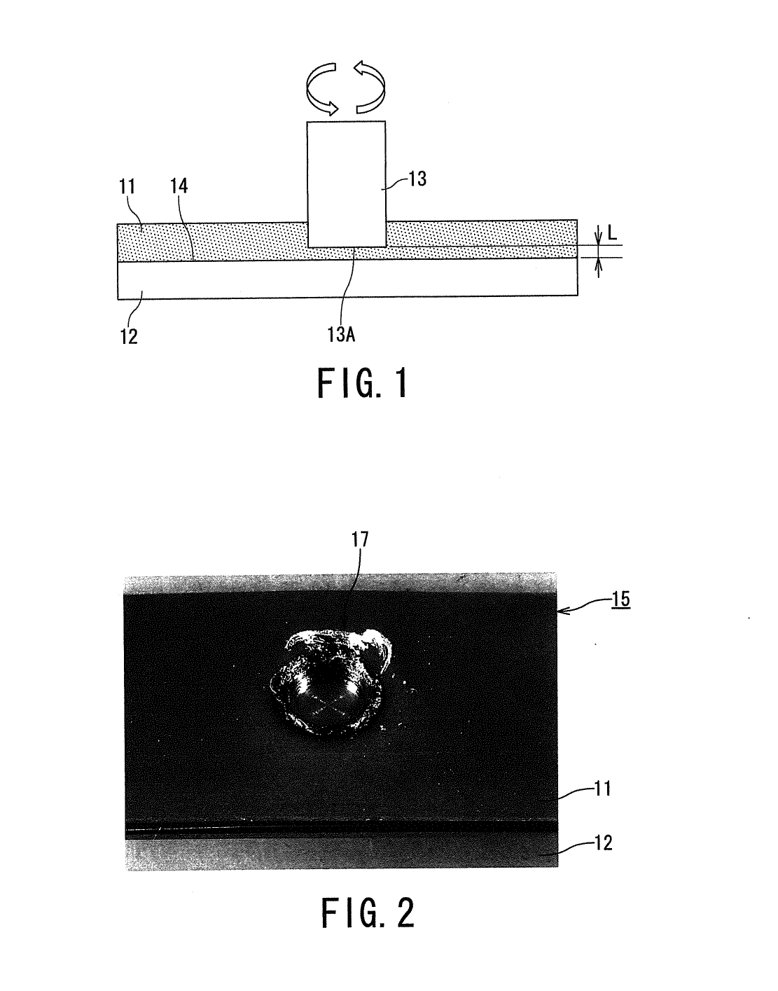

FIG. 1 is a side view schematically showing an operating situation of a friction stir welding method to which one embodiment of the method of bonding dissimilar metal materials is applied. In the method of bonding dissimilar metal materials according to this embodiment, dissimilar (different) materials each having a different melting point, i.e., a high melting point material and a low melting point material are superposed and subjected to a spot welding.

As the high melting point material, an iron member, particularly, a steel member 11 having a melting point of about 1500° C. is used. On the other hand, as the low melting point material, an aluminum member (including aluminum alloy) 12 having a melting point of about 580 to 650° C. is used. In this regard, the aluminum member 12 is not limited to an expanded member such as A6061 member, but a cast member such as AC4CH member or the like and a die cast member such as ADC12 member or the like can be also used.

In the friction stir welding method of this embodiment, firstly, the steel member 11 and the aluminum member 12 are superposed and positioned to a portion at which a bonding (welding) is to be performed. At this time, the steel member 11 is positioned at an upper side while the aluminum member 12 is positioned at a lower side, respectively.

Next, a rotation tool 13 is abutted against the steel member 11 while the rotation tool 13 is rotated, and then, the rotation tool 13 is inserted into the steel member 11. In this connection, the rotation tool 13 is made of a tool steel such as SKD61 or the like or made of a die steel, and the rotation tool 13 is formed to have a shape of a round bar having a diameter of 3 to 10 mm. Further, a rotation number of the rotation tool 13 is set to within a range of 75 to 750 rpm.

When the rotation tool 13 is inserted into the steel member 11, an insertion position (insertion depth) of the rotation tool 13 is controlled to a position at which the steel member 11 is not broken through by the rotation tool 13. Concretely, the insertion position of the rotation tool 13 is controlled to a position so that a top end portion 13A of the rotation tool 13 is positioned to a portion deviated toward a side of the steel member 11 at a distance L (L=0.05 to 0.6 mm) from a mating surface 14 of the steel member 11 and the aluminum member 12.

When the above friction stir spot-welding is performed, a friction heat is generated at a portion between the steel member 11 and the rotation tool 13, so that the steel member 11 is softened so as to cause a plastic flow. While a temperature of the aluminum member 12 close to the rotation tool 13 is partially arisen, so that the aluminum member 12 is also softened so as to cause a plastic flow.

Then, portions of the steel member 11 and the aluminum member 12 that are close to the rotation tool 13 and exhibiting the plastic flow are stirred by a rotating motion of the rotation tool 13, so that the steel member 11 and the aluminum member 12 are subjected to a friction-stir spot-welding operation.

Friction stir welding bonded bodies 15, 18, 21 as the dissimilar metal materials bonded bodies obtained by this friction stir spot-welding method are respectively shown in FIGS. 2, 3, 4 and 5.

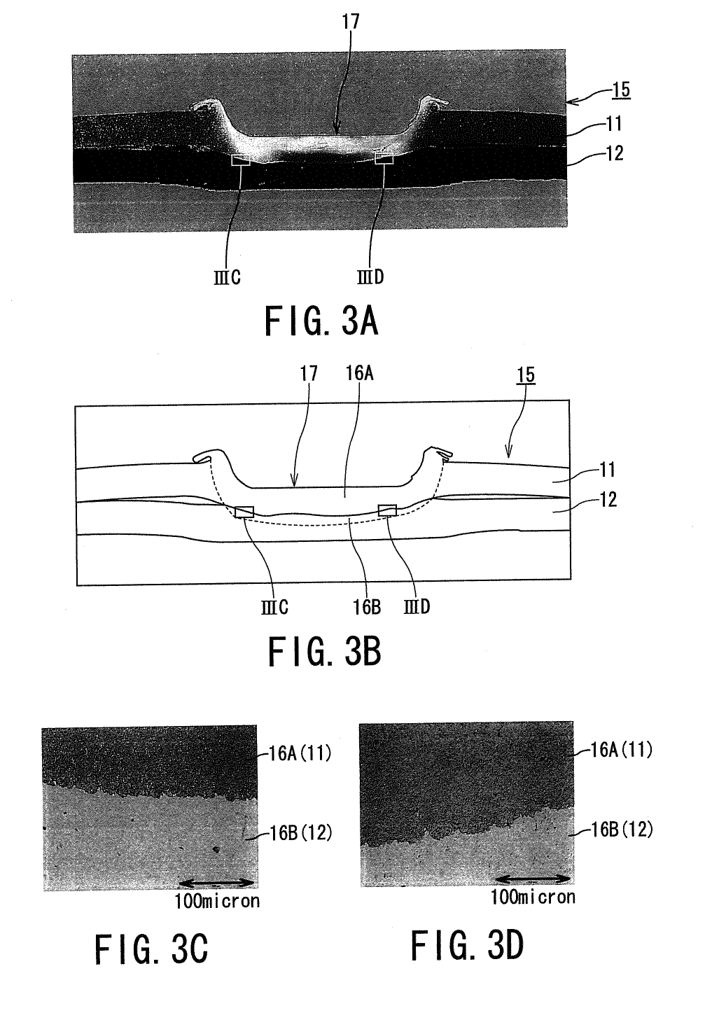

The friction stir welding bonded bodies 15 shown in FIGS. 2 and 3 are obtained in such a manner that a bare mild steel plate (tensile strength: 270 MPa) as the steel member 11 having a thickness of 1 mm and an A6061 aluminum expanded material (tensile strength: 300 MPa) as the aluminum member 12 having a thickness of 1 mm are superposed, then the steel member 11 (bare mild steel plate) and the aluminum member 12 (aluminum expanded plate) are subjected to the friction-stir spot-welding operation under the following bonding conditions.

The above bonding conditions are as follows. Namely, a rotation tool 13 made of SKD61 having a diameter of 6 mm and having a round bar shape is used. A rotation number of this rotation tool 13 is set to 500 rpm. An inserting speed of the rotation tool 13 is set to 20 mm/min. The rotation tool 13 is inserted into the steel member 11 until a top end portion 13A of the rotation tool 13 reaches to a position deviated at a distance of 0.3 mm to a side of the steel member 11 from a mating surface 14 between the steel member 11 and the aluminum member 12. In this connection, a retention time ranging from a time of completion of the insertion of the rotation tool 13 to a time of drawing out of this rotation tool 13 is set to 1 second.

In this friction stir welding bonded body 15, a stirred portion 16A at a side of the steel member 11 (bare mild steel plate) stirred by the rotation tool 13 and a stirred portion 16B at a side of the aluminum member 12 (aluminum expanded plate) are bonded (spot-welded) thereby to form a bonded portion 17. In these features, as shown in FIGS. 3C and 3D, it can be confirmed that a metallic structure of the stirred portion 16B at the side of the aluminum member 12 is finely miniaturized thereby to increase strength of the metallic structure.

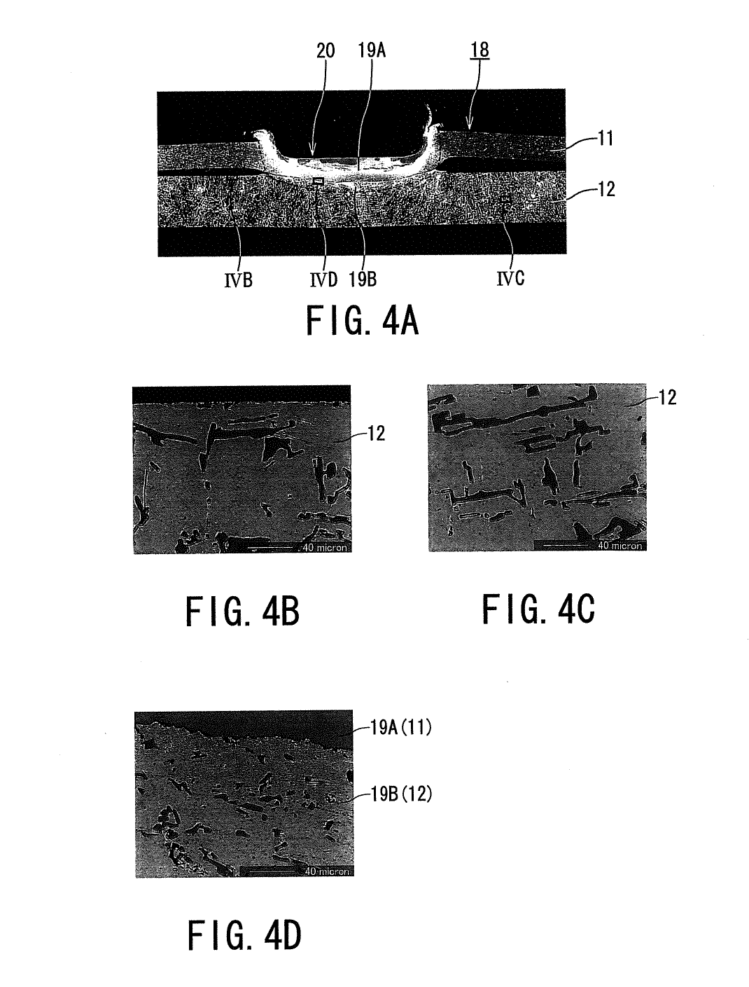

Further, the friction stir welding bonded body 18 shown in FIG. 4 is obtained in such a manner that the bare mild steel plate as the steel member 11 having a thickness of 1 mm and an AC4CH aluminum cast member as the aluminum member 12 having a thickness of 2 mm are superposed, then the steel member 11 (bare mild steel plate) and the aluminum member 12 (aluminum cast plate) are subjected to the friction-stir spot-welding operation under the following bonding conditions.

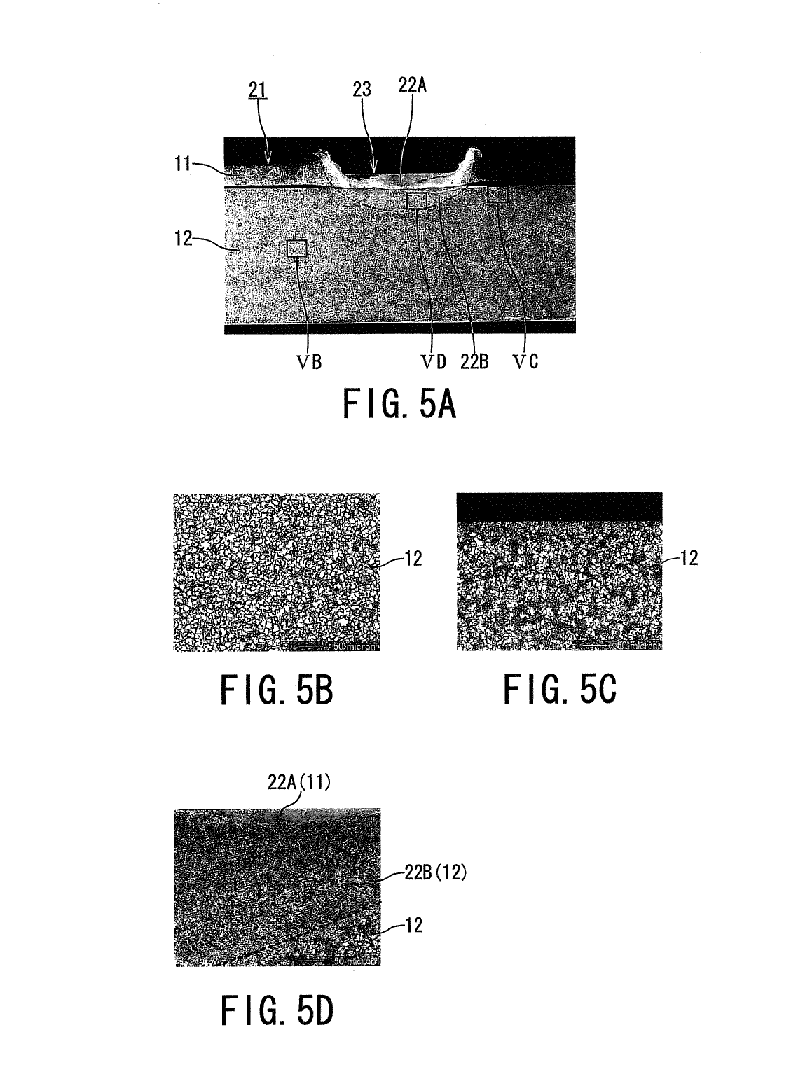

Furthermore, the friction stir welding bonded body 21 shown in FIG. 5 is obtained in such a manner that the bare mild (soft) steel plate as the steel member 11 having a thickness of 1 mm and an ADC12 aluminum die cast plate as the aluminum member 12 having a thickness of 6 mm are superposed, then the steel member 11 (bare mild steel plate) and the aluminum member 12 (aluminum die cast plate) are subjected to the friction-stir spot-welding operation under the following bonding conditions.

The above bonding conditions at a time of the friction stir spot-welding for obtaining the friction stir welding bonded body 18 and the friction stir welding bonded body 21 are as follows. Namely, a rotation tool 13 made of SKD61 having a diameter of 6 mm and having a round bar shape is used. A rotation number of this rotation tool 13 is set to 500 rpm. An inserting speed of the rotation tool 13 is set to 20 mm/min. The rotation tool 13 is inserted into the steel member 11 until a top end portion 13A of the rotation tool 13 reaches to a position deviated at a distance of 0.4 mm to a side of the steel member 11 from a mating surface 14 between the steel member 11 and the aluminum member 12. In this connection, a retention time ranging from a time of completion of the insertion of the rotation tool 13 to a time of drawing out of this rotation tool 13 is set to 1 second.

In also the case of the friction stir welding bonded body 18 shown in FIG. 4, a stirred portion 16A at a side of the steel member 11 (bare mild steel plate) stirred by the rotation tool 13 and a stirred portion 16B at a side of the aluminum member 12 (aluminum cast plate) are bonded (spot-welded) thereby to form a bonded portion 20. In these features, as shown in FIG. 4D, it can be confirmed that a metallic structure of the stirred portion 19B at the side of the aluminum member 12 is finely miniaturized thereby to increase strength of the metallic structure, in comparison with structures of a surface of the aluminum member 12 (show in FIG. 4B) and an inner portion of the aluminum member 12 (show in FIG. 4C). In this regard, a black-colored portion in FIGS. 4B, 4C and 4D denotes silicon component.

In also the case of the friction stir welding bonded body 21 shown in FIG. 5, a stirred portion 22A at a side of the steel member 11 (bare mild steel plate) stirred by the rotation tool 13 and a stirred portion 22B at a side of the aluminum member 12 (aluminum die cast plate) are bonded (spot-welded) thereby to form a bonded portion 23. In these features, as shown in FIG. 5D, it can be confirmed that a metallic structure of the stirred portion 22B at the side of the aluminum member 12 is finely miniaturized thereby to increase strength of the metallic structure, in comparison with structures of an inner portion of the aluminum member 12 (show in FIG. 5B) and a surface of the aluminum member 12 (show in FIG. 5C).

In the aforementioned friction stir spot welding method shown in FIG. 1, a reason why the insertion position (insertion depth) of the top end portion 13A of the rotation tool 13 is controlled to a position deviated at a distance L (L=0.05 mm to 0.6 mm) toward a side of the steel member 11 from a mating surface 14 between the steel member 11 and the aluminum member 12 are as follows. Namely, the steel member 11 softened by the friction heat caused by the rotation tool 13 and the aluminum member 12 softened by the heat conducted from the friction heat are sufficiently stirred by the rotation tool 13 thereby to enable the bonding to provide a high bonding strength.

Namely, when the above deviation distance L is less than 0.05 mm, the steel member 11 is broken through by the rotation tool 13 during the bonding operation of the steel member 11 and the aluminum member 12, so that a bonding surface area of the bonded portion 17 is decreased thereby to remarkably lower a peel strength of the two members. In contrast, when the above deviation distance L exceeds 0.6 mm, the friction heat cannot be sufficiently conducted or transmitted to the aluminum member 12, so that an amount of stirring the aluminum member 12 by the rotation tool 13 becomes small thereby to lower the bonding strength of the two members.

For example, a bare mild steel plate as the steel member 11 having a thickness of 1 mm and an A6061 aluminum expanded material as the aluminum member 12 having a thickness of 1 mm were superposed, then the steel member 11 and the aluminum member 12 were subjected to the friction-stir spot-welding operation under the following bonding conditions and by varying the deviation distance L of the top end portion 13A of the rotation tool 13 from the mating surface 14 of the steel member 11 and the aluminum member 12.

At this time of the friction-stir spot-welding operation, the bonding conditions were as follows. Namely, a rotation tool 13 made of SKD61 having a diameter of 6 mm and having a round bar shape was used. A rotation number of this rotation tool 13 was set to 500 rpm. A retention time ranging from a time of completion of the insertion of the rotation tool 13 to a time of drawing out of this rotation tool 13 was set to 1 second.

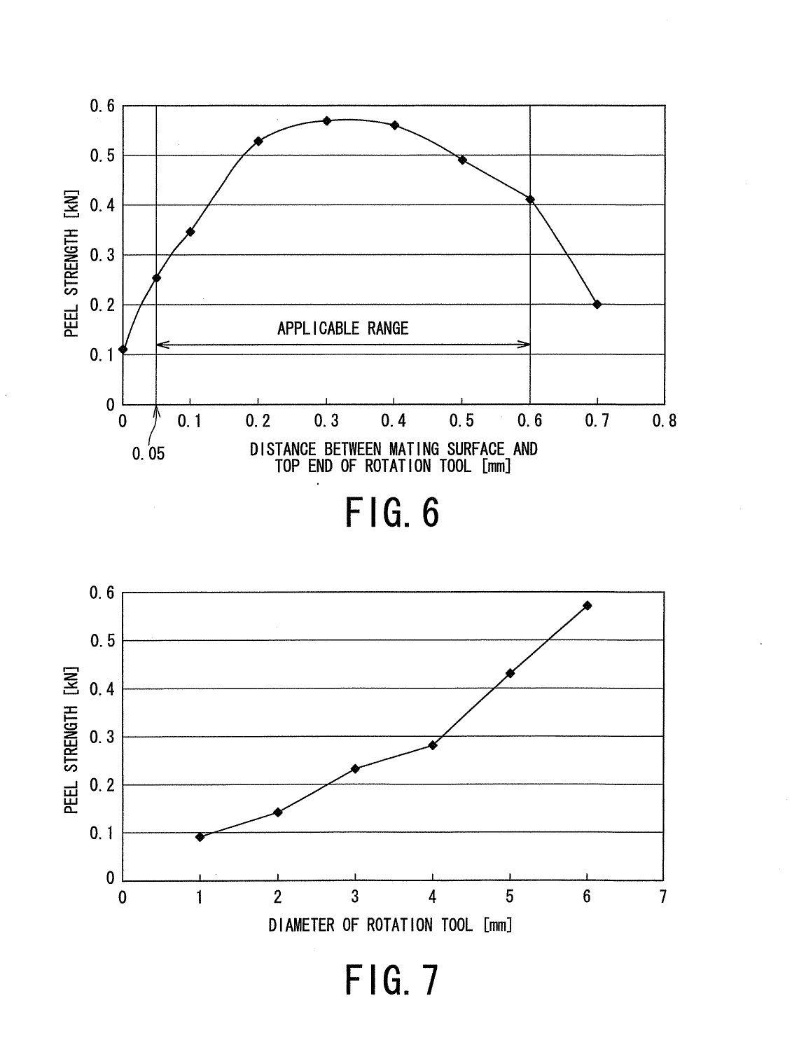

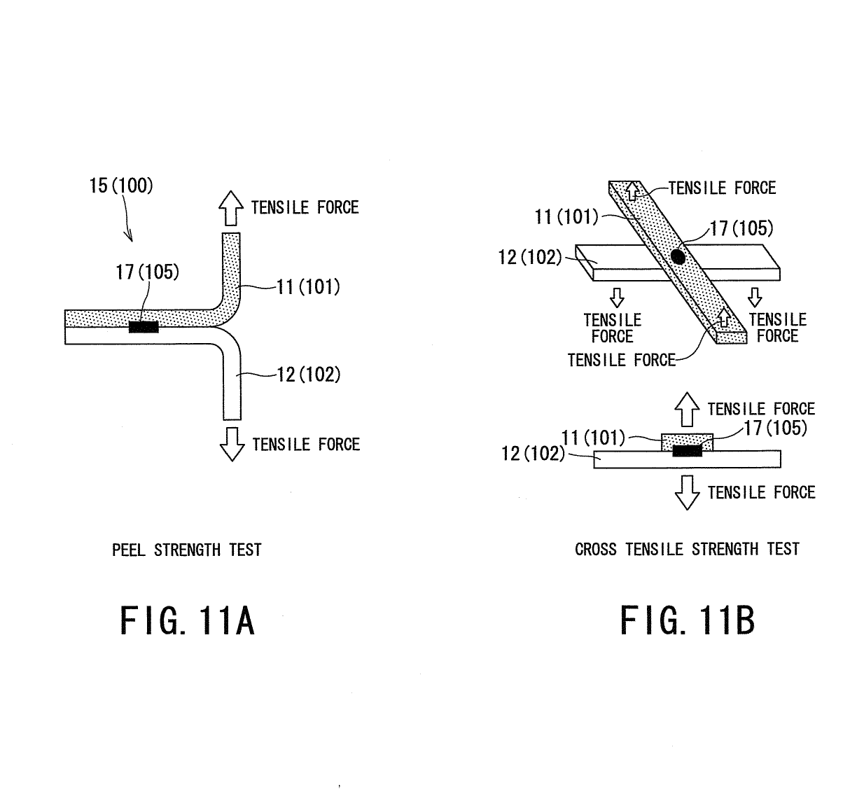

With respect to each of thus obtained friction stir welding bonded bodies 15, a peel strength test shown in FIG. 11A was performed, and the test results are shown in Table 1 and FIG. 6. In this regard, a test piece for the peel strength test was prepared in accordance with Japanese Industrial Standard (JIS Z3144).

As shown in Table 1 and FIG. 6, in case of the friction stir welding bonded bodies 15 in which the rotation tool 13 was inserted into the steel member 11 such that the top end portion of the rotation tool 13 was positioned to portions deviated at distances L of 0 mm and 0.7 mm to a side of the steel member 11 from the mating surface 14 of the steel member 11 and the aluminum member 12, the peel strengths were low to be 0.12 kN and 0.20 kN.

In contrast, in case of the friction stir welding bonded bodies 15 in which the rotation tool 13 was inserted into the steel member 11 such that the top end portion of the rotation tool 13 was positioned to portions deviated at distances L of 0.05 mm to 0.6 mm toward a side of the steel member 11 from the mating surface 14 of the steel member 11 and the aluminum member 12, the peel strengths were high values to be 0.25 kN or more. Accordingly, it was confirmed that the steel member 11 and the alumni member 12 were welded and bonded with a high bonding strength.

TABLE 1
Relation between Insertion Depth of
The Rotation Tool and Peel Strength

| | Distance L (mm) between Mating Surface and | | | | | | | | |
|---|---|---|---|---|---|---|---|---|---|
| | End Portion of Rotation Tool | | | | | | | | |
| | 0 | 0.05 | 0.1 | 0.2 | 0.3 | 0.4 | 0.5 | 0.6 | 0.7 |
| Peel | 0.12 | 0.26 | 0.35 | 0.53 | 0.57 | 0.56 | 0.49 | 0.41 | 0.20 |
| Strength | | | | | | | | | |
| (kN) | | | | | | | | | |

In the aforementioned friction stir spot welding method shown in FIG. 1, a reason why the rotation tool 13 is formed to have a round bar shape having a diameter of 3 mm to 10 mm is that an excessive heat generation (friction heat) due to contact of the rotation tool 13 with the steel member 11 is suppressed, so that a wear-out or breakage of the rotation tool 13 can be prevented, and a sufficient bonding strength can be secured.

Namely, when the diameter of the rotation tool 13 exceeds 10 mm, a heat generated by the contact of the rotation tool 13 with the steel member 11 becomes excessively large, so that the rotation tool 13 is liable to be worn-out or broken. On the other hand, when the diameter of the rotation tool 13 is less than 2 mm, a bonding surface area of the bonded portion 17 between the steel member 11 and the aluminum member 12 becomes small, so that the bonding strength is practically lowered. Accordingly, the diameter of the rotation tool 13 is set to 3 mm or more.

For example, a bare mild steel plate as the steel member 11 having a thickness of 1 mm and an A6061 aluminum expanded material as the aluminum member 12 having a thickness of 1 mm were superposed, and the diameter of the rotation tool 13 was changed as shown in Table 2, then the steel member 11 and the aluminum member 12 were subjected to the friction-stir spot-welding operation under the following bonding conditions.

At this time of the friction-stir spot-welding operation, the bonding conditions were as follows. Namely, a rotation tool 13 made of SKD61 having a round bar shape was used. A rotation number of this rotation tool 13 was set to 500 rpm. An inserting speed of this rotation tool 13 was set to 20 mm/min. The rotation tool 13 was inserted into the steel member 11 so that the top end portion 13A of the rotation tool 13 was positioned to a portion deviated at a distance of 0.3 mm toward the steel member 11 from the mating surface 14 between the steel member 11 and the aluminum member 12. A retention time ranging from a time of completion of the insertion of the rotation tool 13 to a time of drawing out of this rotation tool 13 was set to 1 second.

With respect to each of thus obtained friction stir welding bonded bodies 15, a peel strength test shown in FIG. 11A was performed, and the test results are shown in FIG. 7. Further, a state of each of the rotation tools 13 after completion of each friction stir spot-welding operations are shown in Table 2. In also this case, a test piece for the peel strength test was prepared in accordance with Japanese Industrial Standard (JIS Z3144).

As is clear from the results shown in Table 2, in a case where the diameter of the rotation tool 13 is 11 mm or more, an amount of the heat (friction heat) generated by friction of the steel member 11 and the rotation tool 13 became excessively large, so that wear-out and damage of the rotation tool 13 were observed.

Further, in a case where the diameter of the rotation tool 13 is 2 mm or less, a bonding surface area of the bonded portion 17 between the steel member 11 and the aluminum member 12 became to be small, so that it was confirmed that the bonding strength (peel strength) is disadvantageously lowered as shown in FIG. 7. Therefore, the results show that it is desirable to use a rotation tool 13 having a diameter of 3 mm or more from a viewpoint of the bonding strength of the steel member 11 and the aluminum member 12

TABLE 2
Relation between Diameter of Rotation
Tool and Wear of The Rotation Tool

| | Diameter of Rotation Tool (mm) | | | | | |
|---|---|---|---|---|---|---|
| | Ø 5 | Ø 6 | Ø 8 | Ø 10 | Ø 11 | Ø 12 |
| State of | No | No | No | No | Wear | Wear |
| Rotation Tool | Wear | Wear | Wear | Wear | Observed | Observed |
| after Welding | | | | | | |

Furthermore, in the aforementioned friction stir spot welding method shown in FIG. 1, a reason why the rotation number of the rotation tool 13 at a time of bonding operation is set to 75 rpm to 750 rpm is that an excessive heat generation (friction heat) due to contact of the rotation tool 13 with the steel member 11 is suppressed, so that a wear-out or breakage of the rotation tool 13 can be prevented, and a sufficient bonding strength between the steel member 11 and the aluminum member 12 can be secured.

Namely, when the rotation number of the rotation tool 13 exceeds 750 rpm, a heat generated by the contact of the rotation tool 13 with the steel member 11 becomes excessively large, so that the rotation tool 13 is liable to be worn-out or broken. On the other hand, when the rotation number of the rotation tool 13 is less than 75 rpm, an amount of the heat generated by contact of the rotation tool 13 with the steel member 11 becomes excessively small, so that the bonding strength between the steel member 11 and the aluminum member 12 is disadvantageously lowered.

For example, a. bare mild steel plate as the steel member 11 having a thickness of 1 mm and an A6061 aluminum expanded material as the aluminum member 12 having a thickness of 1 mm were superposed, and the rotation number of the rotation tool 13 at the bonding operation was changed as shown in Table 3, then the steel member 11 and the aluminum member 12 were subjected to the friction-stir spot-welding operation under the following bonding conditions.

At this time of the friction-stir spot-welding operation, the bonding conditions were as follows. Namely, a rotation tool 13 made of SKD61 having a round bar shape and having a diameter of 6 mm was used. An inserting speed of this rotation tool 13 was set to 20 mm/min. The rotation tool 13 was inserted into the steel member 11 until the top end portion 13A of the rotation tool 13 was positioned to a portion deviated at a distance of 0.3 mm toward the steel member 11 from the mating surface 14 between the steel member 11 and the aluminum member 12. A retention time ranging from a time of completion of the insertion of the rotation tool 13 to a time of drawing out of this rotation tool 13 was set to 1 second.

With respect to each of thus obtained friction stir welding bonded bodies 15 that were obtained by changing the rotation number of the rotation tool 13, a bonded state was observed. The observation results are shown in Table 3.

As is clear from the results are shown in Table 3, in a case where the rotation number of the rotation tool 13 was 50 rpm, an amount of the heat (friction heat) generated by friction of the steel member 11 and the rotation tool 13 became excessively small, so that the bonding of the steel member 11 and the aluminum member 12 was insufficient.

In contrast, in a case where the rotation number of the rotation tool 13 was set to within a range of 75 rpm to 750 rpm, the bonding of the steel member 11 and the aluminum member 12 was sufficient.

Further, in a case where the rotation number of the rotation tool 13 was set to 800 rpm or more, although the bonding of the steel member 11 and the aluminum member 12 was sufficient, the amount of the heat generated by contact of the steel member 11 and the rotation tool 13 became excessively large, so that the wear-out of the rotation tool 13 was observed.

TABLE 3
Difference in Bonding State depending on Rotation Number of the Rotation Tool

| | Rotation Number (rpm) | | | | | | | | | | |
|---|---|---|---|---|---|---|---|---|---|---|---|
| | 50 | 75 | 100 | 200 | 300 | 400 | 500 | 600 | 700 | 750 | 800 |
| Bonding | Non- | Good | Good | Good | Good | Good | Good | Good | Good | Good | Wear |
| State | Bonded | | | | | | | | | | Generated |

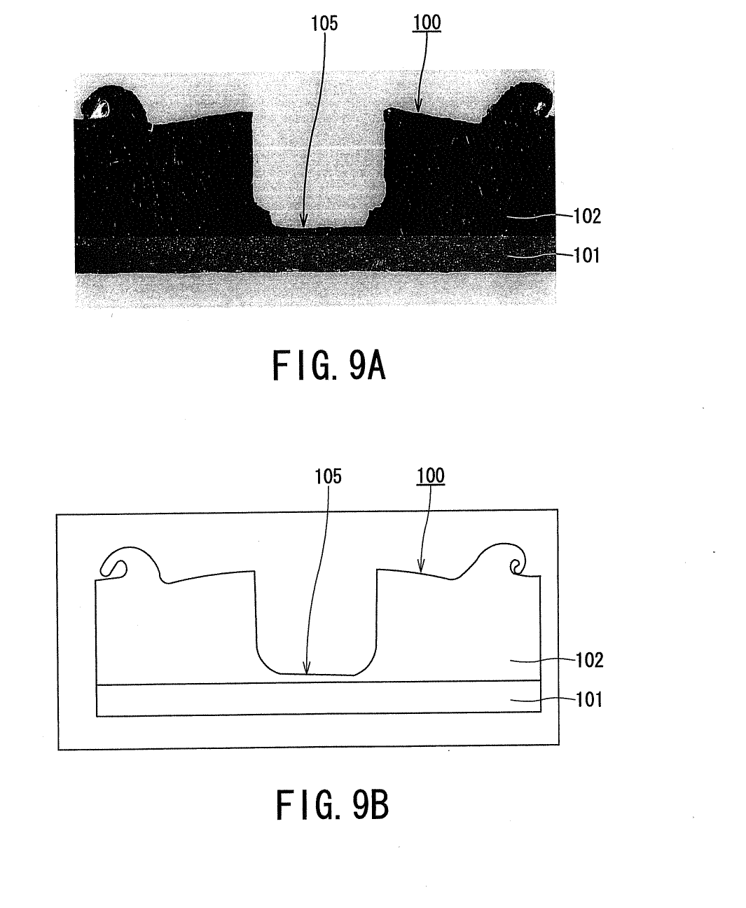

Next, with respect to the friction stir welding bonded body 15 shown in FIGS. 2, 3 and a friction stir welding bonded body 100 shown in FIG. 9 obtained by a conventional friction stir welding method (Patent Literature 1), a peel strength and a cross tension (tensile) strength will be compared.

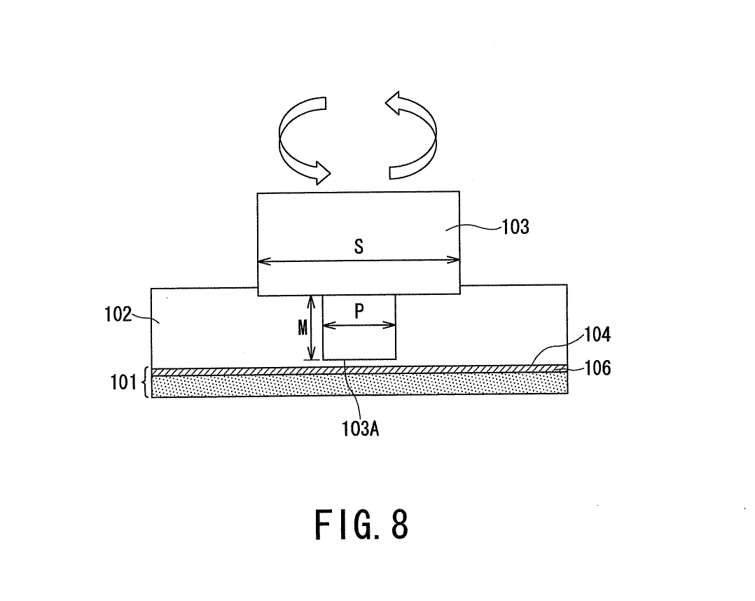

In the aforementioned conventional friction stir welding method, as shown in FIG. 8, a Zn (zinc) plated steel plate 101 as the steel member 101 having a thickness of 1 mm and an A6061 aluminum expanded material as the aluminum member 102 having a thickness of 4 mm were superposed, and a friction stir welding tool (FSW tool) 103 was inserted into the aluminum member 102 from a side thereof, then the steel member 101 and the aluminum member 102 were subjected to the friction-stir spot-welding operation under the following bonding conditions. In this connection, a reference sign 106 denotes a Zn (zinc) plating layer.

Afore-mentioned bonding conditions are as follows. Namely, a friction stir welding tool 103 having a shoulder diameter S of 12 mm, a probe diameter P of 5 mm and a probe length M of 3.5 mm was used. This friction stir welding tool 103 was inserted from a side of the aluminum member 102. A rotation number of this friction stir welding tool 103 was set to 1500 rpm. An inserting speed of this friction stir welding tool 103 was set to 20 min/min. An insertion amount of this friction stir welding tool 103 was set to 3.7 mm (i.e., the top end portion 103A of the friction stir welding tool 103 was positioned to a portion deviated at a distance of 0.3 mm toward the aluminum member 102 from a mating surface 104 between the steel member 101 and the aluminum member 102). A retention time ranging from a time of completion of the insertion of the friction stir welding tool 103 to a time of drawing out of this friction stir welding tool 103 was set to 2 second.

In the friction stir welding bonded body 15 shown in FIG. 9, that was obtained by the aforementioned conventional friction stir welding method shown in FIG. 8, a reference sign 105 denotes a bonded portion.

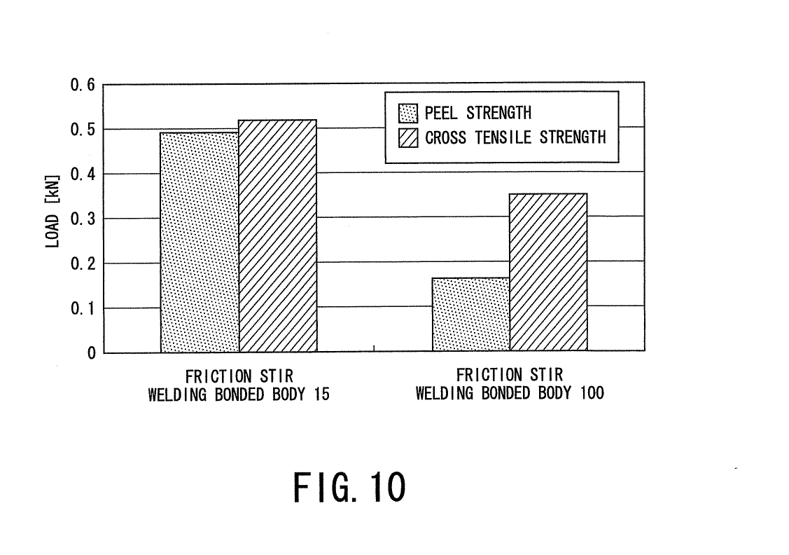

With respect to each of thus obtained friction stir welding bonded body 100 and the friction stir welding bonded bodies 15 shown in FIGS. 2 and 3, a peel strength test and a cross tensile test shown in FIG. 11 were performed. At this time, a test piece for the peel strength test was prepared in accordance with Japanese Industrial Standard (JIS Z3144) while a test piece for the cross tensile strength test was prepared in accordance with Japanese Industrial Standard (JIS Z3137), respectively. These strength test results are shown in Table 4 and FIG. 10.

As is clear from the results shown in Table 4, in the friction stir welding bonded body 15 obtained by the friction stir welding method according to one disclosed embodiment, the peel strength is improved to be about three times higher and the cross tensile strength is improved to be about one and a half (1.5) times higher in comparison with the friction stir welding bonded body 100 obtained by the conventional friction stir welding method.

TABLE 4
Comparison in Strength of Friction Stir Welding Bonded Bodies

| | Friction Stir Welding | Friction Stir Welding |
|---|---|---|
| | Bonded Body 15 | Bonded Body 100 |
| Peel Strength | 0.49 | 0.16 |
| Cross Tensile Strength | 0.52 | 0.35 |

Since the disclosed embodiment is configured as described above, the embodiment can exhibit the following advantageous effects (1) to (5).

Since the rotation tool 13 is inserted into the steel member 11 from a side of the steel member 11, the steel member 11 is softened to generate a friction heat so as to attain to a temperature at which the steel member 11 causes a plastic flow, while the aluminum member 12 is also softened due to a heat conducted from the friction heat. Therefore, the steel member 11 and the aluminum member 12 each exhibiting the plastic flow can be partially and sufficiently stirred at a portion close to this rotation tool 13, so that these steel member 11 and the aluminum member 12 can be bonded (welded) with a high bonding strength.

The insertion position (insertion depth) of the rotation tool 13 is controlled to a portion at which the rotation tool 13 does not break through the steel member 11, i.e., the top end portion 13A of the rotation tool 13 is controlled to move to a portion deviated at a distance of at least 0.05 mm toward a side of the steel member 11 from a mating surface 14 between the steel member 11 and the aluminum member 12, a bonding surface area of the bonded portion 17 between the steel member 11 and the aluminum member 12 can be sufficiently secured. As a result, the bonding strength, particularly, the peel strength of the steel member 11 and the aluminum member 12 can be greatly improved.

Since the insertion position (insertion depth) of the rotation tool 13 is controlled such that the top end portion 13A of the rotation tool 13 is controlled so as to move to a position deviated at a distance L (L=0.05 mm to 0.6 mm) toward a side of the steel member 11 from a mating surface 14 between the steel member 11 and the aluminum member 12, both the steel member 11 and the aluminum member 12 can be softened by the friction heat and sufficiently stirred by the rotation tool 13. As a result, the bonding strength of the steel member 11 and the aluminum member 12 can be improved.

Since the rotation tool 13 is formed to have a round bar shape having a diameter of 3 mm to 10 mm, a heat generation caused by the friction between the rotation tool 13 and the steel member 11 is adequately suppressed, so that a wear-out or breakage of the rotation tool 13 can be effectively prevented.

Since the rotation number of the rotation tool 13 at a time of bonding operation is set to 75 rpm to 750 rpm, the heat generation caused by the friction between the rotation tool 13 and the steel member 11 is adequately suppressed, so that the wear-out or breakage of the rotation tool 13 can be effectively prevented.

Although the present invention has been explained herein above on the basis of the embodiments, the present invention is not limited to these embodiments. For example, the friction stir welding tool (FSW tool) having a shoulder portion shown in FIG. 8 can be also used as the rotation tool 13. However in this case, when the shoulder portion contacts with the steel member 11, the shoulder portion would be worn-out in a short time due to the heat generation. Therefore, it should be noted and desirable that this shoulder portion is carefully handled so as not to contact with the steel member 11.

1. A method of bonding dissimilar metal materials each having a different melting point, the method comprising:
positioning a high melting point metal material and a low melting point metal material at a bonding position at which the dissimilar metal materials are bonded;
press-contacting a rotation tool to the high melting point metal material while the rotation tool is rotated, and inserting the rotation tool into the high melting point metal material;
controlling an insertion position of the rotation tool to a position where the rotation tool do not break through the high melting point metal material;
producing a friction heat at a portion between the high melting point metal material and the rotation tool;
partially softening the high melting point metal material and the low melting point metal material by a conduction heat conducted from the friction heat thereby enabling the high and low melting point metal material to cause a plastic flow; and
partially stirring the high melting point metal material and the low melting point metal material by the rotation tool thereby friction-stir welding the high melting point metal material and the low melting point metal material.

2. The method of bonding dissimilar metal materials according to claim 1, wherein the insertion position of the rotation tool is controlled to a position at which an end portion of the rotation tool is positioned at a location which is deviated from a mating surface of the high melting point metal material and the low melting point metal material at a distance of 0.05 to 0.6 mm toward a side of the high melting point metal material.

3. The method of bonding dissimilar metal materials according to claim 1, wherein the rotation tool is made of steel and formed to provide a round bar shape, and a diameter of the rotation tool is set to 3 to 10 mm.

4. The method of bonding dissimilar metal materials according to claim 1, wherein a rotation speed of the rotation tool is set to 75 to 750 rpm.

5. The method of bonding dissimilar metal materials according to claim 1, wherein the high melting point metal material is an iron member, while the low melting point metal material is an aluminum member.

6. A dissimilar metal materials bonded body obtained by bonding a high melting point metal material and a low melting point metal material through the method of bonding dissimilar metal materials of claim 1.

7. A dissimilar metal materials bonded body obtained by bonding a high melting point metal material and a low melting point metal material through the method of bonding dissimilar metal materials of claim 2.

8. A dissimilar metal materials bonded body obtained by bonding a high melting point metal material and a low melting point metal material through the method of bonding dissimilar metal materials of claim 3.

9. A dissimilar metal materials bonded body obtained by bonding a high melting point metal material and a low melting point metal material through the method of bonding dissimilar metal materials of claim 4.

10. A dissimilar metal materials bonded body obtained by bonding a high melting point metal material and a low melting point metal material through the method of bonding dissimilar metal materials of claim 5.
